(19) United States
(12) Patent Application Publication
(10) Pub. No.: US 2009/0099923 A1
(43) Pub. Date: Apr. 16, 2009

(54) SPACECRAFT ADVERTISEMENT SYSTEMS AND METHODS

(76) Inventor: Jesse D. Koenig, San Diego, CA (US)

Correspondence Address: MINTZ, LEVIN, COHN, FERRIS, GLOVSKY AND POPEO, P.C, ONE FINANCIAL CENTER, BOSTON, MA, 02111, US

(21) Appl. No.: 12/237,240

(22) Filed: Sep. 24, 2008

Related U.S. Application Data
(60) Provisional application No. 60/995,245, filed on Sep. 24, 2007.

(51) Int. Cl. G06Q 30/00

(52) U.S. Cl. 705/14

(57) ABSTRACT

A spacecraft is deployed in outer-space and an advertisement is displayed on the spacecraft. This provides the advertisement with an outer space background that can be recorded by equipment on the spacecraft, and then displayed at a terrestrial location.

### REFERENCE TO PRIORITY DOCUMENT

This application claims priority of co pending U.S. Provisional Patent Application Ser. No. 60/995,245, filed on Sep. 24, 2007. The disclosures of the Provisional Patent Applications are hereby incorporated by reference in their entirety.

### BACKGROUND

The present disclosure relates to a system and method for the presentation of advertisements. More particularly, the present disclosure relates to a system and method of presenting advertisements in outer space.

Advertising is a common way for a seller of goods and services to generate sales. In traditional media, such as television and print media, an advertisement is seen by a variety of people. The advertisement generally originates from a terrestrial location. In recent years, the Internet has provided a new and powerful medium for advertising. The explosion of creative ways to advertise via the Internet has upped the ante for ways to capture the attention of the public in viewing advertisements.

There is clearly a broad fascination with outer space among the public. This fascination is increasing with the growth of space tourism that will soon become accessible to the general public. In addition, there is an increasing move for the government to send astronauts back to the moon and possibly on to Mars, which is helping to generate even more interest in outer space. As an example of this, a golf company recently paid millions of dollars to have an astronaut hit a golf ball from the International Space Station. Also, a university spacecraft project led by the Massachusetts Institute of Technology currently has many sponsors that pay to place logos and messages on the body of a spacecraft.

In view of the foregoing, there is a need for ways to capitalize on the public's growing fascination with outer space in combination with ways to capture the public's attention in advertisements.

### SUMMARY

Disclosed is a system and method for displaying advertisements. A spacecraft is deployed in outer-space and an advertisement is displayed on the spacecraft. This provides the advertisement with a grand outer space background that can be recorded by equipment on the spacecraft, and then displayed at a terrestrial location.

In an embodiment, there is disclosed an advertising method, comprising: deploying a spacecraft in an outer space location, wherein the spacecraft includes a display screen and a camera having a field of view that may include at least a portion of the display screen and at least a portion of an outer space environment of the spacecraft; displaying an advertisement on the display screen; recording the camera's field of view to obtain an image of the advertisement and the outer space environment; transmitting the image to a terrestrial location; and displaying the image at a terrestrial location.

Other features and advantages will be apparent from the following description of various embodiments, which illustrate, by way of example, the principles of the disclosed devices and methods.

### BRIEF DESCRIPTION OF THE DRAWINGS

FIG. 1 shows an image of an exemplary spacecraft that incorporates the advertisement system and method described herein.

FIG. 2 shows a schematic view of the spacecraft 100, which may include various electronic and software components.

### DETAILED DESCRIPTION

While the present systems and methods are described with respect to an Earth-orbiting satellite-type spacecraft, the systems and methods can be used with other types of spacecraft, such as spacecraft that land on or orbit the moon, Mars, or any other astronomical body, as well as those that travel through interplanetary space.

Disclosed is a space-based advertising system. The system includes a spacecraft 100 having an image screen 103 that is adapted to show images and/or video such as with respect to an advertising component. The images and/or video can be uploaded to the spacecraft from a remote location, such as a terrestrial-based location. The spacecraft 100 is coupled to a camera, such as a high definition camera 107 that is configured to record footage of the spacecraft and the screen. The camera 107 can be configured so that it records footage of the screen 103, spacecraft 100, and/or background images with respect to the spacecraft, such as the surface of the moon, Mars, an asteroid, etc.

The footage can then be remotely downloaded to a different location, such as for display at a terrestrial location. The advertising component could be on a spacecraft that had a different main mission. For example, the main mission could be an astronomical observatory, but the advertising component could pay the costs of conducting the mission, and could end up being profitable. The spacecraft could be fixed in one place, as in a stationary observatory on the surface of an astronomical body; it could be moveable, as in a rover; it could be in orbit around some astronomical body; or it could be traveling through interplanetary space.

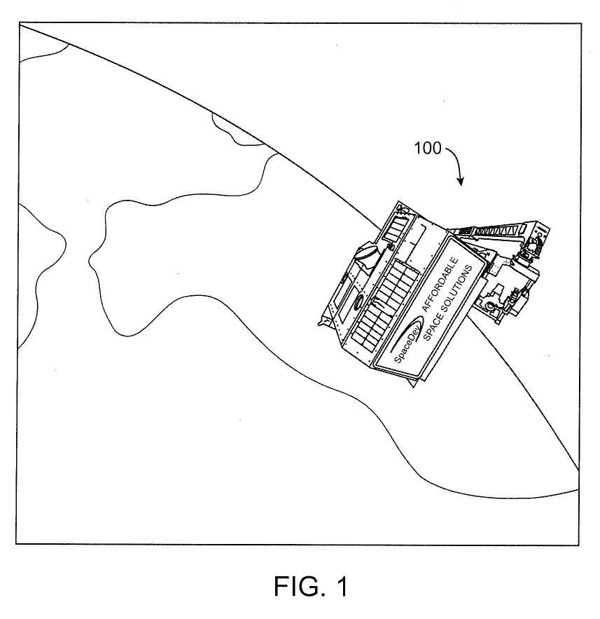

FIG. 1 shows an image of an exemplary spacecraft 100 in outer space. Although shown in the context of the spacecraft 100 being an Earth-orbiting satellite, it should be appreciated that the disclosed systems and methods can be adapted for use with other types of spacecrafts. It should be appreciated that the spacecraft can have various structural configurations such as expandable trusses and/or solar panels. In an exemplary embodiment, any custom image or video can be uploaded to the spacecraft for display on the screen. The displayed image or video on the color or black and white screen is recorded by a camera positioned on the spacecraft. The screen and camera are mounted on the satellite which will be in orbit around the Earth. Thus, the blue and green sphere of Earth rotating in the background against the blackness of outer space is recorded by the camera. As mentioned, the spacecraft does not necessarily have to be in orbit around the Earth. The spacecraft can be at any of a variety of outer space or non-terrestrial locations, such as the moon, some other astronomical body, or interplanetary space.

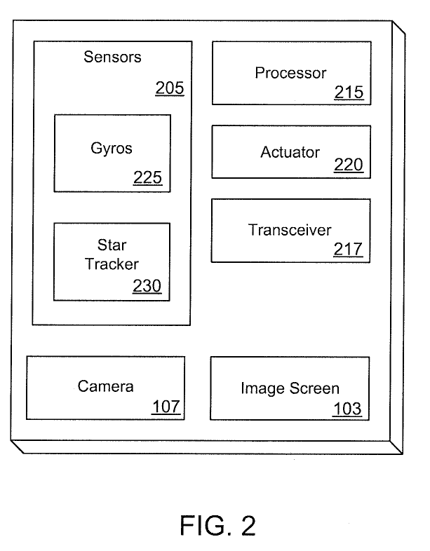

FIG. 2 shows a schematic view of the spacecraft 100, which may include various electronic and software components. The components described in FIG. 2 are for example only and it should be appreciated that the spacecraft 100 is not limited to the configuration shown in FIG. 2. As mentioned, the spacecraft may include an image screen 103 and a camera 107 that may be pointed at least partially at the image screen 103. The camera may be pointed at the screen 103 such that at least a portion of the screen 103 is within the field of view of the camera. In this manner, the camera 107 can record the screen 103. The field of view of the camera 107 also desirably is configured so that it includes at least a portion the surrounding area or environment of the spacecraft. In this manner, the camera 107 not only records the screen 103, but also records background images such as Earth from space, outer space, or non-terrestrial images. The direction that the camera faces can be remotely changed such as from a terrestrial location or a different outer space location.

The configuration of the image screen 103 can vary. For example, the image screen 103 can be a plasma or liquid crystal display (LCD). The screen 103 can be for example, reflective TFT (thin film transistor), CCFL (cold cathode fluorescent lamp), LED (light-emitting diode), or OLED (organic light-emitting diode). Other types of image screens can be used.

The spacecraft 100 may include multiple sensors 205 such as for the estimation of the attitude and rates of the spacecraft 100. Desired attitude state profiles may be determined and generated by a main processor 215, or received from another spacecraft or ground stations via a transceiver 217. A control actuator 220 can provide torques and accelerations to effect motion of the spacecraft 100.

The sensors 205 may include gyros 225, star trackers 230, or other sensors known in the art for the estimation and determination of the attitude of the spacecraft 100. Any quantity of each of the sensors 205 may be utilized. The processor 215 may be microprocessor-based such as a computer having a central processing unit, memory (RAM and/or ROM), and associated input and output buses. The processor 215 may be an application-specific integrated circuit or may be formed of other logic devices known in the art. The processor 215 may be a portion of a central control unit or may be a stand-alone processor, as shown. The control actuator 220 is generally a torque-generating device and may be in various forms. The control actuator 220 may include multiple thrusters, reaction wheels, control moment gyros, magnets, some combination of these, or may be in some other form known in the art. As mentioned, the components described in FIG. 2 are for example only and it should be appreciated that the spacecraft 100 is not limited to the configuration shown in FIG. 2.

According to a method, the spacecraft 100 is deployed into outer space either from a terrestrial location or from another outer space location, such as from a space station. An advertisement is then uploaded to the spacecraft such that the advertisement is displayed on the screen 103. The advertisement can be uploaded to the spacecraft, for example, by transmitting the advertisement from a remote location to the spacecraft, such as via a radio-frequency communication. The advertisement can be a static image or it may be a moving image such as a video image. Alternately, the advertisement can be pre-stored in memory of the spacecraft rather than uploaded.

Next, the camera 107 is activated. If necessary, the camera is reoriented such that the screen 103 is at least partially contained within the field of view of the camera. The field of view also includes the background or surrounding area of the spacecraft, such as a view of Earth, outer space or a non-terrestrial astronomical body. As used herein, the term “terrestrial” refers to Earth. The camera then records the image that is being displayed on the screen 103 as well as the background or environment of the spacecraft. The spacecraft may generate a signal to verify that the camera is in the correct orientation. For example, the camera's image may be temporarily fed to a verification location. Once it is verified that the camera's field of view is correct (i.e., it contains the advertisement and the outer space environment), the camera 107 records the image.

The camera feed can be downloaded in real time to a terrestrial location for display at any of a wide variety of terrestrial locations. Alternately, the camera feed can be stored locally and downloaded at a later time. The image that is being displayed on the screen 103 can be changed while the camera is recording the screen 103. The change in image can be commanded from a remote location, either from a terrestrial location or from another outer space location. In this manner, the image that is being displayed on the screen and recorded by the camera can be changed in real time.

The camera may record at a reduced frame rate, giving playback with a sped up background, such as for dramatic Earth rotation, sun rise, etc. in the background of the image or video on the screen. With a video on the spacecraft screen in such a scenario, the spacecraft screen would play the video in slow motion as it was recorded by the camera at reduced frame rate. Then, when the camera's recording is played back, the video on the spacecraft screen plays in real-time, while the background is sped up. If not sped up, the background of a satellite in orbit appears almost motionless; therefore, speeding the image up provides for a more dramatic advertisement experience.

It is to be understood that the subject matter described herein is not limited to particular embodiments described, and as such may of course vary. It is also to be understood that the terminology used herein is for the purpose of describing particular embodiments only, and is not intended to be limiting. Unless defined otherwise, all technical terms used herein have the same meaning as commonly understood by one skilled in the art to which this subject matter belongs.

As will be apparent to those of skill in the art upon reading this disclosure, each of the individual embodiments described and illustrated herein has discrete components and features which may be readily separated from or combined with the features of any of the other several embodiments without departing from the scope of the subject matter described herein. Any recited method can be carried out in the order of events recited or in any other order which is logically possible.

A number of embodiments have been described. Nevertheless, it will be understood that various modifications may be made without departing from the spirit and scope of the invention. Accordingly, other embodiments are within the scope of the invention.

1. An advertising method, comprising:
deploying a spacecraft in an outer space location, wherein the spacecraft includes a display screen and a camera having a field of view that may include at least a portion of the display screen and at least a portion of an outer space environment of the spacecraft;
displaying an advertisement on the display screen;
recording the camera's field of view to obtain an image of the advertisement and the outer space environment;
transmitting the image to a terrestrial location; and
displaying the image at a terrestrial location.

2. A method as in claim 1, wherein the image comprises a static image.

3. A method as in claim 1, wherein the image comprises a video image.

4. A method as in claim 1, wherein the image is transmitted in real time as the image is recorded.

5. A method as in claim 1, further comprising storing the image at a location local to the spacecraft and then transmitting the stored image to the terrestrial location.

6. A method as in claim 1, wherein the camera records the display screen and outer space environment at a reduced frame rate, and further comprising displaying the camera's recording at a frame rate that is greater than the reduced frame rate.

7. A method as in claim 6, further comprising displaying a video advertisement in slow motion while the camera records the display screen at a reduced frame rate, such that when the camera's recording is played back at a rate greater than that at which it was recorded, the video advertisement appears in real-time.

8. A method as in claim 1, wherein the outer space location is an orbit around the Earth.

9. A method as in claim 1, wherein the outer space location is an orbit around a non-Earth astronomical body.

10. A method as in claim 1, wherein the outer space location is the surface of a non-Earth astronomical body.

11. A method as in claim 1, wherein the outer space location is interplanetary space.
